(19) United States
(12) Patent Application Publication
(10) Pub. No.: US 2008/0086401 A1
(43) Pub. Date: Apr. 10, 2008

(54) CHARTING WITH DEPTH OF MARKET VOLUME FLOW

(75) Inventor: Timothy S. Mather, Englewood, CO (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: CQGT, LLC, Denver, CO (US)

(21) Appl. No.: 11/828,264

(22) Filed: Jul. 25, 2007

Related U.S. Application Data
(60) Provisional application No. 60/833,095, filed on Jul. 25, 2006.

(51) Int. Cl. G06F 17/40; G06F 17/10; G06Q 40/00

(52) U.S. Cl. 705/35

(57) ABSTRACT

Systems and methods are described for generating depth of market (DOM) volume flow charts. According to various embodiments, the DOM volume of a financial instrument is monitored. The DOM volume can include volume elements corresponding to bid order volume and/or ask order volume of orders for the financial instrument that are open on an electronic exchange. A DOM volume flow may then be computed, according to some embodiments, by evaluating a function of one or more elements of the DOM volume and/or a change in the DOM volume elements. Then, indicators of the computed DOM volume flow may be displayed on a chart.

### CROSS-REFERENCE TO RELATED APPLICATIONS

This application claims the benefit of Provisional Application No. 60/833,095, filed on Jul. 25, 2006, which is hereby incorporated by reference for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2006-2007 CQG Inc.

### TECHNICAL FIELD

Various embodiments of the present invention generally relate to displaying information related to financial instruments. More specifically, embodiments of the present invention relate to systems and methods for generating depth of market volume flow charts.

### BACKGROUND

In the field of financial trading, trading of financial instruments (e.g., securities, commodity, currency, or index futures, options, etc.) is typically done today through an electronic exchange, rather than on the historical “trade floor”. Trading through an electronic exchange enables virtually anyone with a computer to trade directly with the exchange. Via a trader's computer that accesses the exchange via a network, the trader can obtain real-time or historical financial data, place trade orders (e.g., bids and asks), perform a wide range of financial analyses, and much more. In addition, data can be presented to the trader in various useful formats, such as graphical or alphanumeric. The type of data presented, the manner and timeliness of presentation, and the data manipulations performed by the trader's financial application are important factors that can more or less improve the trader's ability to make informed decisions and profit in the market.

For example, financial data may be presented in the form of a bar chart. Conventionally, a price bar chart includes a vertical line (a bar) representing the range of prices spanned for a security in one day of trading. The top of the vertical line indicates the highest price a security traded at during the day, and the bottom represents the lowest price. The closing price is displayed on the right side of the bar, and the opening price is shown on the left side of the bar. While conventional methods for generating and presenting bar charts can be useful, they are generally fairly limited in their indication of current and likely future trends of financial data. Of course, traders would prefer to be able to predict future prices with a high degree of confidence in order to increase their chances of profitability. As such, other methods for presenting bar charts, and computing their corresponding data, are desired.

### SUMMARY

Systems and methods are described for generating depth of market (DOM) volume flow charts. According to various embodiments, the DOM volume of a financial instrument is monitored. The DOM volume can include volume elements corresponding to bid order volume and/or ask order volume of orders for the financial instrument that are open on an electronic exchange. A DOM volume flow may then be computed, according to some embodiments, by evaluating a function of one or more elements of the DOM volume and/or a change in the DOM volume elements. Then, indicators of the computed DOM volume flow may be displayed on a chart.

According to various embodiments, the DOM volume flow study chart includes indicators of net change in ask order volume and bid order volume over a determined time period. In one embodiment the determined time period may be fixed, while in other embodiments the determined time period may be dynamic. In some embodiments, the indicators can indicate direction of change, relative magnitude of change, and/or order volume pressure.

In some embodiments, a plurality of bid/ask range bars may be displayed across the chart with DOM volume flow illustrated with indicators. In one embodiment, the indicators are arrows above and/or below each of the bars. For example, the arrows above the bars may be used to indicate ask DOM volume flow, while DOM volume flow indicators below the bars represent bid DOM volume flow. The direction that the arrows point indicate whether the net change in the DOM volume flow for the time period of the bar was positive or negative. In some embodiments, the arrows can be colored certain colors to further indicate DOM volume flow direction and magnitude.

According to various embodiments, the net change in bid DOM volume flow and ask DOM volume flow over a determined time period may be determined by a computing or evaluating a function of the DOM volume. In one embodiment, the function of DOM volume is a weighted sum of net changes during the time period of the DOM volumes corresponding to a specified number of DOM price levels on either side of the inside market. Some electronic exchanges only provide information to a limited number of DOM price levels on either side of the market (e.g., five values on either side). In one embodiment, the weighted average defaults to using the four DOM price levels on either side of the inside market for the DOM volume flow calculations.

In some embodiments, the DOM volume flow data may be displayed as an overlay on a bid/ask range chart. The display of the DOM volume flow may include graphical indicators of direction and magnitude of change. For example, ask DOM volume flow arrows point down when the total weighted net change in ask DOM volume is positive; ask DOM volume flow arrows point up when the total weighted net change in ask DOM volume is negative. Bid DOM volume flow arrows point down when the total weighted net change in bid DOM volume is negative; bid DOM volume flow arrows point up when the total weighted net change in bid DOM volume is positive.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

FIG. 1 illustrates an exemplary operating environment in which embodiments of the present invention may operate.

FIG. 2 illustrates exemplary display of data related to a financial instrument in accordance with various embodiments of the present invention.

FIG. 3 illustrates an exemplary user interface that may be used to configure certain aspects of a bid/ask range bar chart in accordance with one or more embodiments of the present invention.

FIG. 4 illustrates an exemplary user interface that may be used to configure aspects of a bid/ask range volume histogram chart in accordance with some embodiments of the present invention.

FIG. 5 shows exemplary tables representing snapshots of a portion of the depth of market (DOM) and an exemplary DOM volume flow study chart in accordance with one or more embodiments.

FIGS. 6-7 illustrate exemplary user interfaces that enable a user to set up parameters for use in presenting DOM volume flow indicators on bid/ask range bar charts and/or overlays in accordance with embodiments of the present invention.

FIG. 8 illustrates an exemplary DOM volume flow study chart in accordance with various embodiments of the present invention.

FIG. 9 is a flowchart illustrating an exemplary algorithm for generating bid/ask range data points for a selected financial instrument in accordance with one or more embodiments of the present invention.

FIG. 10 is a flowchart illustrating one embodiment of an algorithm for determining whether an advancing event has occurred in accordance with embodiments of the present invention.

FIG. 11 is a flowchart illustrating an exemplary embodiment of algorithm for determining whether an advancing event has occurred in accordance with some embodiments of the present invention.

FIG. 12 is a flowchart illustrating one possible embodiment of algorithm for advancing to a new data point which may be utilized in one or more embodiments of the present invention.

FIG. 13 is a flowchart illustrating an exemplary algorithm for updating the current data point values in accordance with embodiments of the present invention.

FIG. 14 is a flowchart illustrating an exemplary embodiment of algorithm for updating the price and volume values for current data point which may be utilized in various embodiments of the invention.

FIG. 15 is a flowchart illustrating an exemplary DOM volume flow updating algorithm for updating the DOM volume flow values for a current data point in accordance with some embodiments of the present invention.

FIG. 16 illustrates an exemplary computing device upon which embodiments of the present invention can operate.

### DETAILED DESCRIPTION

Various embodiments of the present invention relates generally to displaying information related to financial instruments. More specifically, embodiments of the present invention relate to systems and methods for generating depth of market volume flow charts.

Some embodiments are described for computing depth of market volume flow data values related to order volume of orders for financial instruments at a financial exchange. The depth of market volume flow data values can be used in financial analyses and in generating financial charts. Some embodiments of the present invention relate to determining data points used in generating bars in bar charts. Algorithms are presented that determine when and how the data points are generated. Data points for a bar are determined in a manner that provides information about changes in the inside market price and/or in the order volume. In this manner, a trader may be able to more readily identify possible trends in price, volume, or other financial data. In addition, the timing of generating new data points and their corresponding bars is based on various events of interest in the market. In some algorithms, the events of interest may be used as indicators of changes in market trends.

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

While, for convenience, embodiments of the present invention are described with reference to trading financial instruments, embodiments of the present invention are equally applicable to various other areas where placing bid and ask orders may be beneficial. For the sake of illustration, various embodiments of the present invention have herein been described in the context of computer programs, physical components, and logical interactions within modern computer networks. Importantly, while these embodiments describe various aspects of the invention in relation to modern computer networks and programs, the method and apparatus described herein are equally applicable to other systems, devices, and networks as one skilled in the art will appreciate. As such, the illustrated applications of the embodiments of the present invention are not meant to be limiting, but instead exemplary. Other systems, devices, networks, and exchanges to which embodiments of the present invention are applicable include, but are not limited to, other types of trading and order placement systems and infrastructures. In addition, embodiments are applicable to all levels of computing from the personal computer to large network mainframes and servers.

Terminology

Brief definitions of terms, abbreviations, and phrases used throughout this application are given below.

The phrase “ask DOM volume” for a particular financial instrument generally refers to a specified function of a number of contracts or shares for N ask quotations in the depth of market. In some embodiments, the “ask DOM volume flow” refers to the net change of weighted sum of the number of contracts or shares available at N ask quotations in the depth of market for a financial instrument within a particular financial instrument price range in a finite time period.

The phrase “ask volume” for a particular financial instrument generally refers to the number of contracts or shares traded or, in an alternative embodiment, the number of trades, that occurred at the ask price for the financial instrument within the particular financial instrument price range.

The phrase “bar chart” refers to a graph with one or more window panes that share a common horizontal time scale. Each window pane may display one or more data points for each time point and may have one or more independent value scales.

The phrase “bid/ask range bar” for a particular financial instrument generally refers to the graphical representation of a data point that includes trade volume information as well as an open price, a high price, a low price and a close price.

The phrase “bid DOM volume” for a particular financial instrument generally refers to a specified function of a number of contracts or shares for N bid quotations in the depth of market. In some embodiments, the “bid DOM volume flow” refers to the net change of weighted sum of the number of contracts or shares available at N bid quotations in the depth of market for a financial instrument within a particular financial instrument price range in a finite time period.

The phrase “bid volume” for a particular financial instrument generally refers to the number of contracts or shares traded or, in an alternative embodiment, the number of trades, that occurred at the bid price for the financial instrument within the particular financial instrument price range.

The phrases “chart overlay” or “overlay” refers to the graphical display of one data set in the same window pane as another data set or other data sets.

The terms “connected” or “coupled” and related terms are used in an operational sense and are not necessarily limited to a direct connection or coupling. Thus, for example, two devices or modules may be connected or coupled directly, or via one or more intermediary media, modules, or devices. As another example, devices or modules may be connected or coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrase “depth of market” (DOM) refers to a number of ask price and ask quantity value pairs above the inside market, and a number of bid price and bid quantity value pairs below the inside market, and including the inside market. It comprises the order book for a financial instrument as published by a financial exchange. Some exchanges provide only five pairs above and five pairs below the current market while others provide a more extensive order book.

The term “financial instrument” generally refers to anything that can be traded with quantities and/or prices. Examples of financial instruments include, but are not limited to, securities, currency, index futures, options, treasuries, stocks, bonds, mutual funds, Exchange-Traded Funds (EFTs), stock futures, commodity futures, stock options, commodity options and the like.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

The phrases “inside market” or “bid/ask range” for a particular financial instrument refers to the price region bounded by the currently established best or highest bid price and the currently established best or lowest ask price.

If the specification states a component or feature “may”, “can”, “could”, or “might” be included or have a characteristic, that particular component or feature is not required to be included or have the characteristic.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The phrase “price bar” for a particular financial instrument generally refers to the graphical representation of a data point that includes multiple values. An exemplary data point includes four price values: an open price, which is the first price registered; a high price, which is the highest price registered for the discrete duration of the bar; a low price, which is the lowest price registered for the discrete duration of the bar; and a close price, which is the last price registered for the discrete duration of the bar. Prices considered in constructing the data point may include bids, ask, and trades or just trades exclusively.

The phrase “pre-open period” refers to the period prior to the opening of a financial market for trading during which the financial exchange accepts limit orders and publishes the order book.

The phrase “price bar” for a particular financial instrument generally refers to the graphical representation of a data point that includes an open price, a high price, a low price and a close price.

The phrase “the market is crossed” refers to a market state where the best bid is greater than or equal to the best ask.

The term “responsive” includes completely or partially responsive.

The term “trader” generally refers to anyone using an input device, computerized or otherwise, to place trade orders, either to buy or to sell a specific quantity of a financial instrument, into a market place.

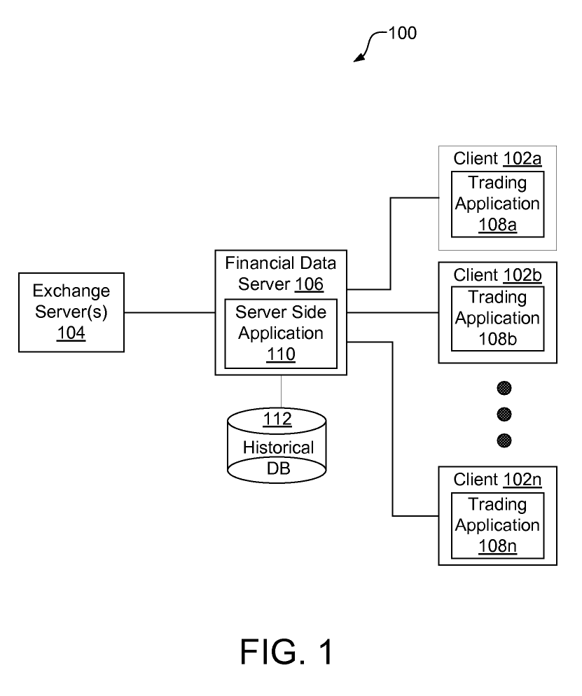

FIG. 1 illustrates an exemplary operating environment 100 in which embodiments of the present invention may be employed. One or more traders use client computers or terminals 102a-n to analyze data and place trade orders at electronic exchange server(s) 104. The electronic exchange server(s) 104 are servers associated with the electronic exchange that accept trade orders, provide requested data, provide a substantially real-time stream of bid, ask, and trade prices and volumes, and other data manipulation related to the electronic exchange. The clients 102a-n communicate with a financial data server 106 that facilitates communication of financial data and placement of trade orders.

Trading applications 108a-n operate on clients 102a-n, respectively. Trading applications 108a-n each gather financial data, process the data, present selected data to the trader on a display (not shown), receive input from the trader, and transmit trade orders to the server 106. More specifically, the trading applications 108a-n communicate with a server side application 110. The server side application 110 is operable to obtain selected data from the exchange server(s) 104 and communicate data to the exchange server(s) 104. Data communicated to the exchange server(s) 104 may be, for example, elements of trade orders, such as buy or sell, quantity, stop or limit prices, or others.

In the embodiment shown, financial data server 106 utilizes a database 112 for storing data, such as historical price, volume data, and order transaction information. Server application 110 and client applications 108a-n can use and present real-time data and historical data from historical database 112. The database 112 may store data in any form suitable for the particular implementation, such as, but not limited to, a relational database and flat files. As such, the database 112 may or may not be accessed via a structured query language (SQL), for example. In addition, financial data server 106 can include cache memory (not shown) for caching selected data, which may be used again later. The server 106 may at times remove selected data from the cache, based on caching rules. In some cases, a trading gateway may facilitate order placement between a trading application and the financial exchange. The trading gateway may be part of the financial data server or may be a separate system component.

In some embodiments, clients 102a-n can subscribe to selected financial instruments, and financial information, or services. Clients 102a-n, financial data server 110, and exchange server(s) 104 communicate via one or more networks. The networks may be wireless, wired, or a combination of wired and wireless. Network components (not shown) and/or components at the clients 102a-n, financial data server 110, and exchange server 104, such as firewalls and network address translators (NATs), may provide for data and system security.

Data communicated between the clients 102a-n and the financial data server 106, and between the financial data server 106 and the exchange server(s) 104 may be “pushed” or “pulled”, or any combination thereof, depending on the situation. For example, akin to pulling, the client 102a may request historical data from the financial data server 106, which will prompt the server side application 110 to retrieve the requested data from the database 112 and send the data to the client 102a. On the other hand, real-time data from the exchange server(s) 104 is typically pushed to one or more of the clients 102a-n by the server side application 110.

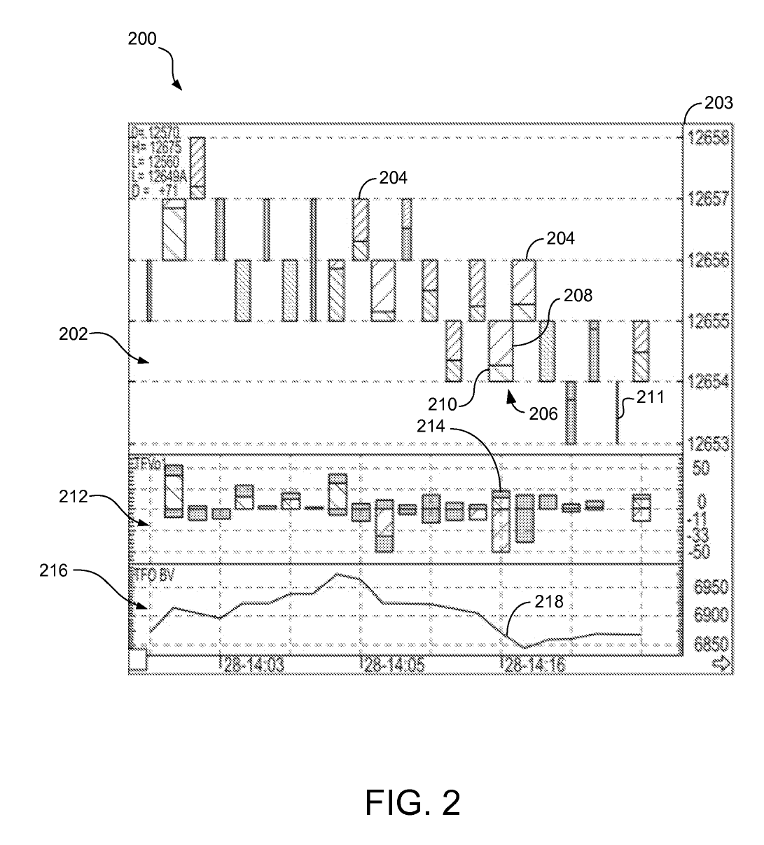

FIG. 2 illustrates an exemplary display 200 of data related to a financial instrument in accordance with one embodiment. The display 200 includes a bid/ask range bar chart 202 providing bid/ask range price and trade volume information. In the embodiment illustrated, the bid/ask range bar chart 202 reflects the directional movement of the best bid/ask range or inside market over time. As such, embodiments can better illustrate short-term historical price and trade volume fluctuations for a financial instrument being monitored.

Each bar 204 in the bar chart 202 corresponds to, or is based upon, a bid/ask range data point. In accordance with various embodiments, a bid/ask range data point includes one or more data values such as, but not limited to a start time, an open price, a high price, a low price, a close price, a mid price, a bid trade volume due to all trades that were executed at the bid price, a bid trade volume due to large trades that were executed at the bid price, a bid DOM volume flow value, an ask trade volume due to all trades that were executed at the ask price, an ask trade volume due to large trades that were executed at the ask price, and an ask DOM volume flow value. Each data point corresponds to a finite time duration during a trading session or trading sessions.

In the embodiment shown in FIG. 2, time is shown along the bottom horizontal axis of chart 200, proceeding from right (most recent) to left (least recent). When a new bar is displayed, the bars in the chart shift to the left, the leftmost (oldest) bar is no longer displayed, and the new bar is displayed to the right of the remaining bars. The new bar is located at a vertical position where the prices of the new bar correspond to the prices along the right vertical price axis 203.

With more specific reference to the bid/ask range bars 204, various attributes of the bid/ask range data points can be presented in different ways to convey information to the viewer. By way of example, different colors and/or color intensities and/or the bar widths can be used to indicate bid trade volume and ask trade volume information to the viewer. According to one embodiment, bid trade volume relative to ask trade volume may be communicated to a trader by visually depicting individual bars 204 of the bar chart 202 in two or more different colors and/or multiple intensities and/or multiple bar widths. For example, the proportion of the total volume traded at the bid for a particular bid/ask range bar 206 may be conveyed by coloring a first portion 208 of the bar 206 a first color (e.g., green, depicted with crosshatching in a first orientation). Within the first portion 208, the amount of trading volume attributed to the bid is depicted with shades of the first color (e.g., shades of green) having increasing visual intensity (e.g., brighter shading) associated with corresponding increases in the total volume of the bar. Similarly, the proportion of the total volume traded at the ask for a particular bid/ask range bar 206 may be conveyed by coloring a second portion 210 of the bar 206 a second color (e.g., red, depicted with crosshatching in a second orientation). Within the second portion 210, the amount of trading volume attributed to the ask is depicted with shades of the second color (e.g., shades of red) having increasing visual intensity (e.g., brighter shading) associated with corresponding increases in the total volume of the data point. Similarly, increases in the total volume of a data point may be conveyed to the viewer by increasing the width of the bar.

According to an alternative embodiment, a bid/ask range bar 204 may be assigned a single uniform color depending on whether it is determined to reflect buying or selling pressure. For example, if the inside market has moved up and the volume traded at the ask price is greater than the volume traded at the bid price, the bar might be colored an intense green reflecting high buying pressure. If the inside market has moved down and the volume traded at the ask price is greater than the volume traded at the bid price, the bar might be colored a less intense green reflecting low buying pressure. Similarly, if the inside market has moved down and the volume traded at the bid price is greater than the volume traded at the ask price, then the bar might be colored an intense red reflecting high selling pressure. If the inside market has moved up and the volume traded at the bid is greater than the volume traded at the ask price, then the bar might be colored a less intense red reflecting low selling pressure.

If no trading occurred for a period of time between two bars, the bid/ask range bar 204 corresponding to that time period might be assigned a neutral color such as grey. This is illustrated in the bid/ask range bar chart 202 in bar 211.

FIG. 2 also illustrates an exemplary bid/ask range volume histogram chart 212. Each histogram bar 214 corresponds to, or is based upon, a bid/ask range data point. Displaying a new histogram bar is done in a similar fashion to a new bid/ask range bar. When a new histogram bar is to be displayed, the leftmost (oldest) histogram bar is no longer displayed. The other remaining bars are shifted to the left, and the new histogram bar is displayed to the right of the bars.

FIG. 2 also illustrates an exemplary bid/ask range on-balance volume line chart 216. The line 218 on the chart corresponds to, or is based upon, an aggregation of the volumes of successive bid/ask range data points. When a new portion of the on-balance line is to be displayed, the line is shifted to the left, with the leftmost (oldest) portion no longer being displayed, and the new portion being added contiguously to the right most end of the on-balance line.

Although the bar chart 202, the histogram 212, and the volume line chart 216 are illustrated together in the display 200, it will be understood by those skilled in the art that these charts can be presented separately or in any combination. For example, in some embodiments, the bar chart 202 is displayed with the volume histogram chart 212, but without the on-balance volume line chart 216. As another example, the on-balance volume line chart 216 may be displayed with the bar chart 202, but without the volume histogram chart 212. In addition, in accordance with various embodiments, the particular combination of charts that are displayed is user configurable.

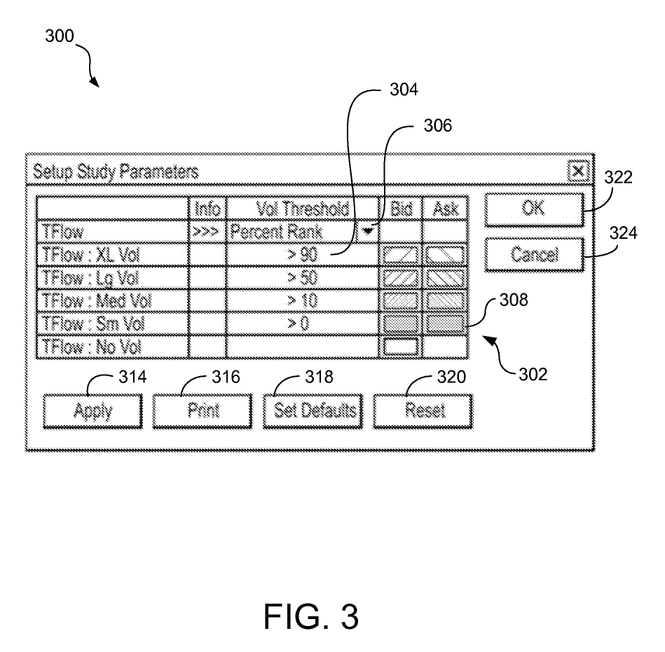

FIG. 3 illustrates an exemplary user interface 300 for configuring certain aspects of a bid/ask range bar chart, such as the bid/ask range bar chart 202. In this embodiment, the user interface 300 is based on the popular Windows™ operating system from Microsoft™ Corporation, however the user interface 300, and other user interfaces described herein, are not limited to the Windows™ operating system. For example, embodiments described herein could be readily adapted to the Linux™ operating systems, or other operating systems. Included in the user interface 300 are a number of user selectable and/or configurable elements, with which the user can set parameters used in presenting bar charts.

According to the illustrated embodiment, a user interactive volume-based color range table 302 enables the user to set colors and color intensities associated with different volume thresholds, for use in displaying bars in the bar chart. The user can select a volume threshold type using the volume threshold mode selector such as drop down menu 306, and set volume thresholds using threshold specification elements 304, to distinguish between different volume thresholds. In the particular example shown, the threshold values are specified as a percentage rank of the total volume for the current data point relative to the total volume of a pre-determined number of prior (historical) data points. In this particular embodiment, there are five volume levels: extra large (XL Vol), large (Lg Vol), medium (Med Vol), small (Sm Vol), and zero volume (No Vol). To illustrate just one possible configuration, in FIG. 3, the extra large volume threshold is set at 90%, the threshold for the large volume threshold is set at 50%, the threshold for the medium volume threshold is set at 10%, and the threshold for the small volume threshold is set at 0%. Of course, these volume thresholds are purely exemplary and could be changed to any other values that the user desires.

For each volume threshold, the user can specify a color and a shade for the portion of the bid/ask range bar representing the bid volume and for the portion of the bid/ask range bar representing the ask volume, as well as zero volume threshold, using color specification elements 308. Thus, according to the exemplary settings shown in FIG. 3, a bar will be displayed with a bright green portion representing the bid volume and a bright red portion representing the ask volume when the total trade volume is ranked above the upper 90^{th} percentile of the historical total trade volume, a regular green portion representing the bid volume and a regular red portion representing the ask volume when the total trade volume is ranked between the 50^{th} percentile and 90^{th} percentile of the historical total trade volume, a dark green portion representing the bid volume and a dark red portion representing the ask volume when the total trade volume is ranked between the 10^{th} percentile and 50^{th} percentile of the historical total trade volume, and a very dark green portion representing the bid volume and a very dark red portion representing the ask volume when the total trade volume is ranked between 0 and the 10^{th} percentile of the historical total trade volume. A bar for which no bid or ask trade volume (i.e., zero volume) occurred will be colored grey.

According to an alternative embodiment, an end user, such as a trader, may be able to choose to set the volume thresholds that are used to determine the intensity of the color and/or the width of the bid/ask range bars to be volume thresholds expressed as actual volume values or as percentages of a base volume where the base volume may be expressed as an absolute value or be algorithmically determined, for example, by calculating a median or a moving average of the historical volume values. A volume threshold mode drop down menu 306 can be used to set the mode of specifying the volume thresholds. In this embodiment, the volume threshold specification modes are absolute volume, percentage of historical volume, and percentage of a base volume.

To set a color, shade, or intensity for a bid or ask portion of the bid/ask range bar, the user selects (e.g., clicks on with a pointer device) the corresponding color specification element 308. In response, a color selector (not shown) is presented that offers multiple colors and/or shades of colors, from which the user may select.

Other user selectable graphical elements on the user interface 300 include an apply button 314, a print button 316, a set defaults button 318, a reset button 320, an ok button 322, and a cancel button 324. When selected, the apply button 314 causes the user set colors and shades to be applied to the bar chart currently displayed. The set defaults button 318 can be used to set or reset the specified colors, shades, and/or threshold values in the table 302 to default values. Selection of the reset button 320 resets the specified settings, i.e. colors, shades, and/or threshold values in the table 302 to values that existed prior to the user changing those values. The functions of the generic user interface elements described here for user interface 300 are replicated in additional user interfaces 400, 600, and 700 which may be used in various embodiments of the present invention.

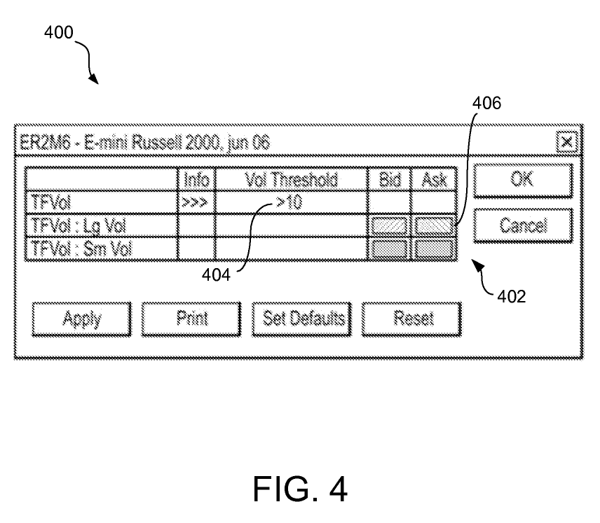

FIG. 4 illustrates an exemplary user interface 400 for configuring aspects of a bid/ask range volume histogram chart, such as volume histogram chart 212 described above. The interface 400 includes a color specification table 402. As in the user interface 300 described above, the user of the user interface 400 can set volume thresholds using threshold specification elements 404, to distinguish between different volume thresholds in bars in the histogram chart. At each volume threshold, the user can select the corresponding color, shade, or intensity using color specification elements 406. When the user selects a color specification element 406, a color selector (not shown) is presented that includes multiple colors or shades, from which the user can choose.

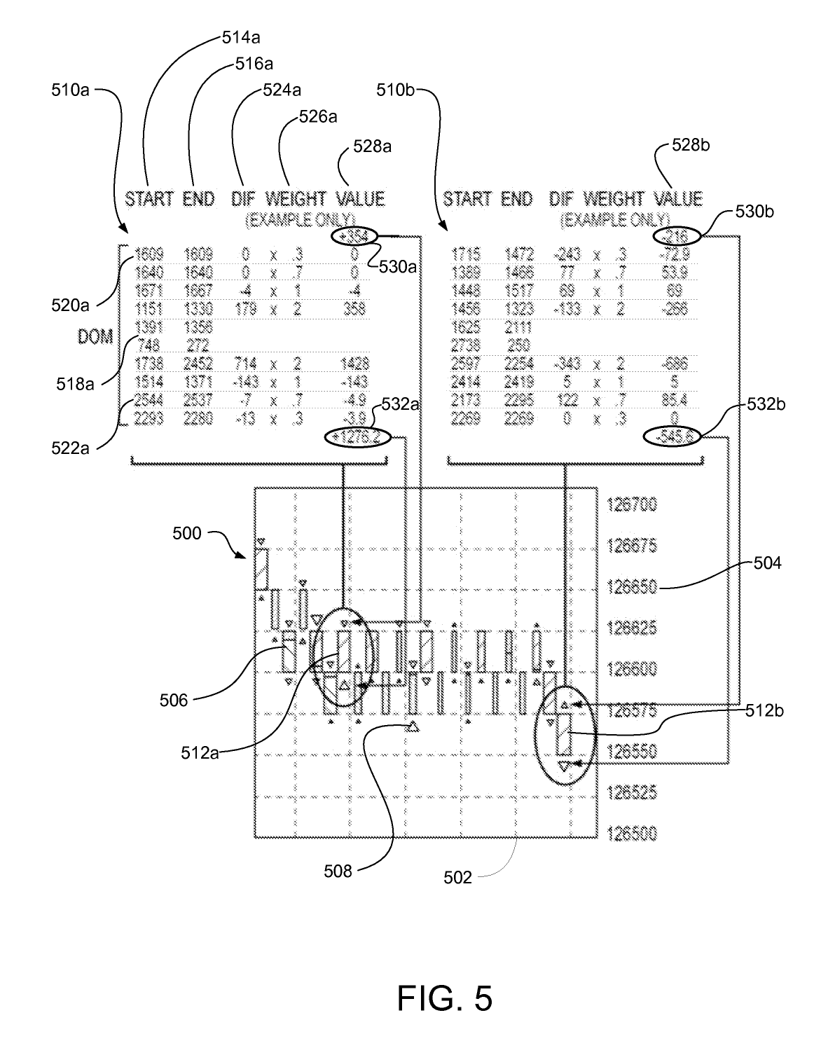

FIG. 5 shows tables representing snapshots of a portion of the depth of market (DOM). In actual operation of some embodiments of the present invention, the DOM tables would not be presented to the user as shown in FIG. 5. The DOM tables are shown in FIG. 5 to illustrate how DOM volume flow indicators may be derived in accordance with one embodiment.

FIG. 5 illustrates a DOM volume flow chart 500 in accordance with one exemplary embodiment. In general, the DOM volume flow study chart 500 includes indicators of net change in ask order volume and bid order volume over a determined time period. The indicators can indicate direction of change, relative magnitude of change, and/or order volume pressure.

In the DOM volume flow study chart 500, time proceeds from left to right along the horizontal axis 502, while price increases from bottom to top on the vertical axis 504. A plurality of bid/ask range bars 506 are displayed across the chart 500. DOM volume flow is illustrated with indicators, such as arrows 508 above and/or below each of the bars 506. According to the embodiment shown in FIG. 5, the DOM volume flow indicators above the bars 506 indicate ask DOM volume flow, while DOM volume flow indicators below the bars 506 indicate bid DOM volume flow. In some embodiments, the direction that the arrows 508 point indicate whether the net change in the DOM volume flow for the time period of the bar was positive or negative.

To determine the net change in bid DOM volume flow and ask DOM volume flow over a determined time period, a function of DOM volume is computed. In the particular embodiment in FIG. 5, the function of DOM volume is a weighted sum of net changes during the time period of the DOM volumes corresponding to a specified number of DOM price levels on either side of the inside market. In one embodiment, four DOM price levels on either side of the inside market are used for the DOM volume flow calculations. In other embodiments, more or less price levels on either side of the inside market may be used for the DOM volume flow calculations. For illustration purposes, an exemplary DOM table 510a is shown for a first bar 512a. The DOM table 510a includes a start volume column 514a and an end volume column 516a that include volume data corresponding to the start and end times of the bar 512a, respectively.

The inside market 518a is shown in the middle of the DOM table 510a. Volume values above the inside market 518a correspond to ask DOM volumes 520a, while volume values below the inside market 518a correspond to bid DOM volumes 522a. A difference column 524a in the DOM table 510a contains the differences between the values in the start volume column 514a and end volume column 516a at each price level. A weight column 526a contains a numerical weight at each price level. Each weight 526a is applied to its associated net difference 524a at that price level. A value column 528a contains resulting values after the weights 526a are applied to the net differences 524a.

Using the resulting values in the value column 528a an ask DOM volume flow value 530a is determined and a bid DOM volume flow value 532a is determined. The ask DOM volume flow value 530a is used to determine the parameters of the ask DOM volume flow indicator displayed above the bid/ask range bar 512a. The bid DOM volume flow value 532a is used to determine the parameters of the bid DOM volume flow indicator displayed below the bid/ask range bar 512a. Specifically, the resulting values 528a associated with the ask orders 520a are summed together to get the total weighted net change in ask DOM volume over the period. Similarly, resulting values 528a associated with the bid orders 522a are summed together to get the total weighted net change in bid DOM volume over the period.

While the above example illustrated an exemplary DOM volume flow calculation expressed as the weighted sum of the DOM volume differences at the beginning and end of a time period, in other embodiments the most current DOM difference values and the most current DOM volume flow value are determined dynamically as real-time DOM updates are received from the financial exchange. In at least one embodiment, the DOM volume flow value becomes anchored when the end of the time period is signaled by the end of time period determining algorithm.

In some embodiments, the DOM volume flow data may be displayed as an overlay on a bid/ask range chart. The display of the DOM volume flow may include graphical indicators of direction and magnitude of change. For example, ask DOM volume flow arrows (arrows on top of the bars 506) point down when the total weighted net change in ask DOM volume is positive; ask DOM volume flow arrows point up when the total weighted net change in ask DOM volume is negative. Bid DOM volume flow arrows (arrows on bottom of the bars 506) point down when the total weighted net change in bid DOM volume is negative; bid DOM volume flow arrows point up when the total weighted net change in bid DOM volume is positive.

In accordance with various embodiments, the arrows can be colored certain colors to further indicate DOM volume flow direction. In one embodiment, ask DOM volume flow arrows (above) that point up are colored green, while ask DOM volume flow arrows that point down are colored red. Bid DOM volume flow arrows (below) that point up are colored red, while bid DOM volume flow arrows that point down are colored green.

To further illustrate, another DOM table 510b is shown to the right of DOM table 510a. DOM table 510b corresponds to a second bar 512b. Weighted net change values are again computed as before and are contained in value column 528b. In contrast to the first DOM table 510a, the ask DOM volume flow value 530b and the bid DOM volume flow value 532b are negative.

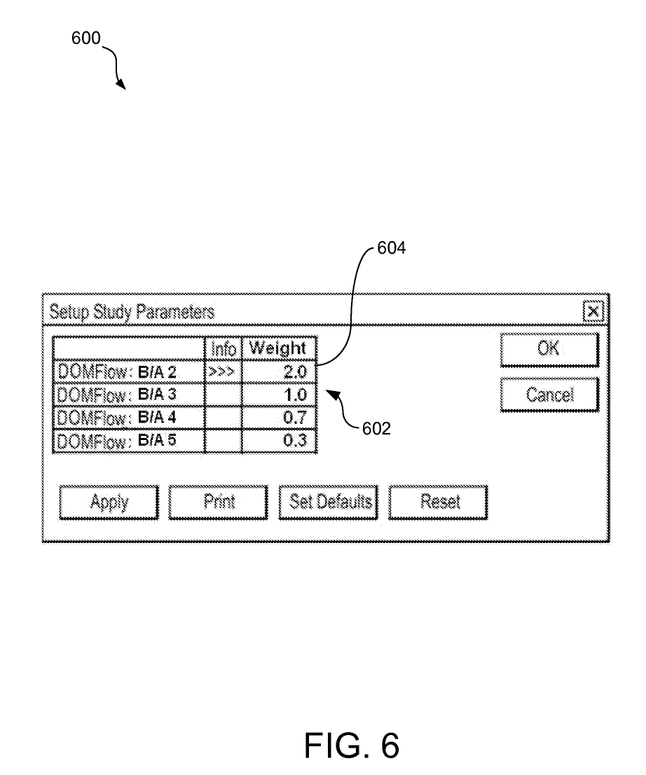

In one embodiment of FIG. 5, weights are user configurable as is illustrated by an exemplary user interface 600 in FIG. 6. According to the illustrated embodiment, a user interactive weights table 602 enables the user to specify the weight 604 for each of the bid and ask price levels. In some embodiments, the user is able to select the number of price levels on either side of the inside market over which to compute the total weighted net change in order volumes.

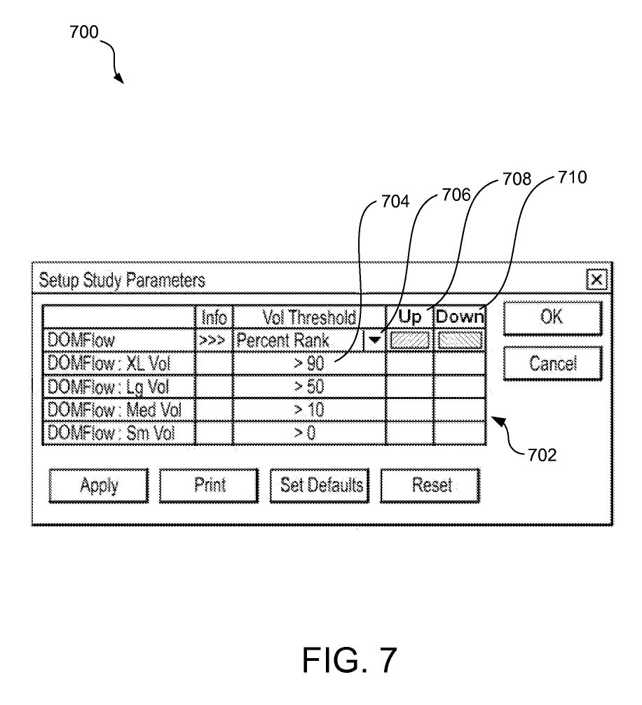

The size of the DOM volume flow arrows may vary depending on DOM volume flow. In one embodiment, the DOM volume flow arrow width and height vary according to the size of the net change in DOM volume flow. In the embodiment of FIG. 5, the levels of net change for purposes of determining arrow dimensions are user controllable and are illustrated by an exemplary user interface 700 in FIG. 7. The DOM volume flow levels may be expressed as absolute values, as a percent rank relative to historical DOM volume flow values, or as percentages of a base volume where the base volume may be expressed as an absolute value or be algorithmically determined, for example, by calculating a median or a moving average of the historical DOM volume flow values. Other algorithms may be used to determine the base volume. Because the volume levels can be quite different for different trading sessions, data may be segregated by session when using the historical data to determine the relative rank or the base volume level.

According to the illustrated embodiment, a user interactive volume-based thresholds and color table 702 enables the user to select a volume threshold type using the volume threshold type selector 706 and set DOM volume net change level thresholds using threshold specification elements 704, to distinguish between the different volume levels that determine the height and width of the DOM volume flow arrows. In the particular example shown, the threshold values are specified as a percentage rank of the DOM volume flow value for the current data point relative to the DOM volume flow values of a pre-determined number of prior (historical) data points. In this particular embodiment, there are four volume flow levels: extra large (XL Vol), large (Lg Vol), medium (Med Vol), and small (Sm Vol). The extra large volume level threshold is 90%, the threshold for the large volume level is 50%, the threshold for the medium.

According to the illustrated embodiment in FIG. 7, color selectors are presented in the interface 700, enabling a user to set the color for positive and negative volume flow. A user may set the color used for the DOM volume flow indicator when the DOM volume flow value is positive by manipulating an Up color selection element 708. The user can set the color used for the DOM volume flow indicator when the DOM volume flow value is negative by manipulating a Down color selection element 710.

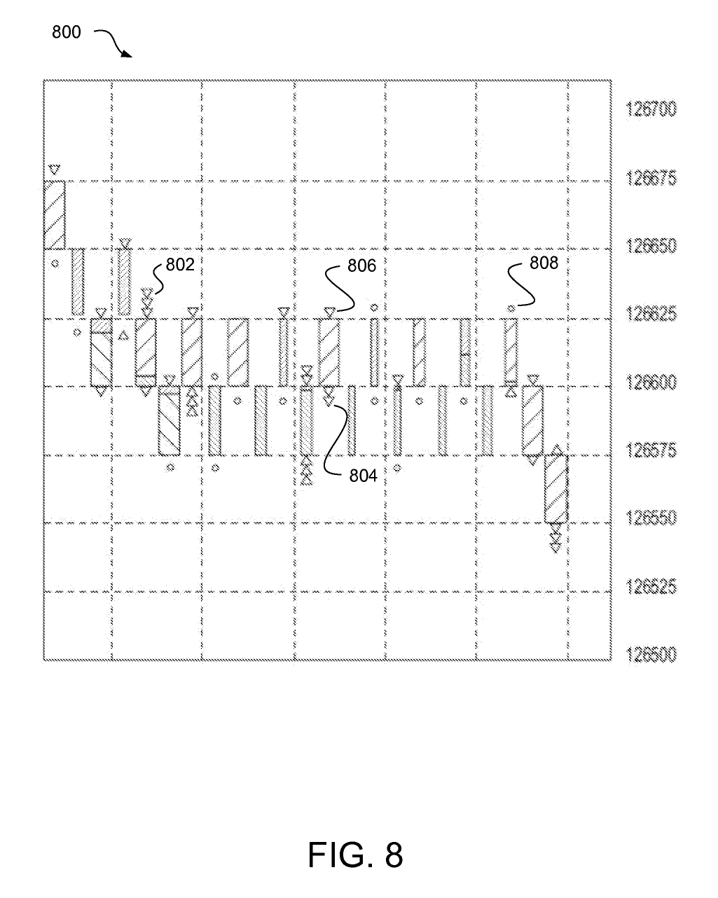

FIG. 8 illustrates a DOM volume flow study chart 800 in accordance with an alternative exemplary embodiment of the DOM volume flow study chart 500 illustrated in FIG. 5. In this particular embodiment, one or more graphical volume flow indicators are displayed above and below the bid/ask range bars, depending on the magnitude of DOM volume flow.

In the embodiment of FIG. 8, multiple graphical volume flow indicators are “stacked” (i.e., displayed in a column) above or below the bar. The indicators can be any shape or meaningful graphic. The number of graphical volume flow indicators depends on the magnitude of volume flow. In FIG. 8, the four volume levels (see FIG. 6) are displayed as follows: 3 stacked triangles or arrows 802 represent extra large volume flow (XL Vol); 2 stacked triangles or arrows 804 represent large volume flow (Lg Vol); 1 stacked triangle or arrow 806 represents medium volume flow (Med Vol), and a small circle 808 represents small volume flow (Sm Vol).

In an alternative embodiment not illustrated herein, DOM volume flow may be displayed as a DOM volume flow histogram chart. The bid DOM volume flow may be displayed as a negative histogram bar and the ask DOM volume flow may be displayed as a positive histogram bar concurrently with, or independent of, a bid/ask range chart and/or a trading interface. The bid DOM volume flow bar may displayed in a first selected color, and the ask DOM volume flow bar may be displayed in a second selected color to further distinguish the bars in the histogram.

The DOM volume flow may then be displayed with the bid DOM volume flow as a negative histogram bar with two colors, for example, dark red for the portion of the bid DOM volume flow resulting from small orders and bright red for the portion of the bid DOM volume flow resulting from large orders. Likewise, the ask DOM volume flow may be displayed as a positive histogram bar with two other colors, for example, dark green for the portion of the ask DOM volume flow resulting from small orders and bright green for the portion of the ask order volume resulting from large orders. Alternatively, the bid DOM volume flow and the ask DOM volume flow may be displayed as overlain positive histogram bars of different colors and widths.

In some embodiments also not illustrated herein, DOM volume flow may be displayed as an DOM volume flow line chart consisting of the two line graphs, one representing the bid DOM volume flow and the other representing the ask DOM volume flow, may be displayed either concurrently with or independent of a bid/ask range chart and/or a bid/ask volume chart and/or a trading interface.

In one embodiment, additional analyses, such as a moving average or rate-of-change calculated using the DOM volume flow values, may be performed and may be displayed either as an overlay on the DOM volume flow line chart or in a separate window pane concurrently with or independent of other analytical displays and/or a trading interface.

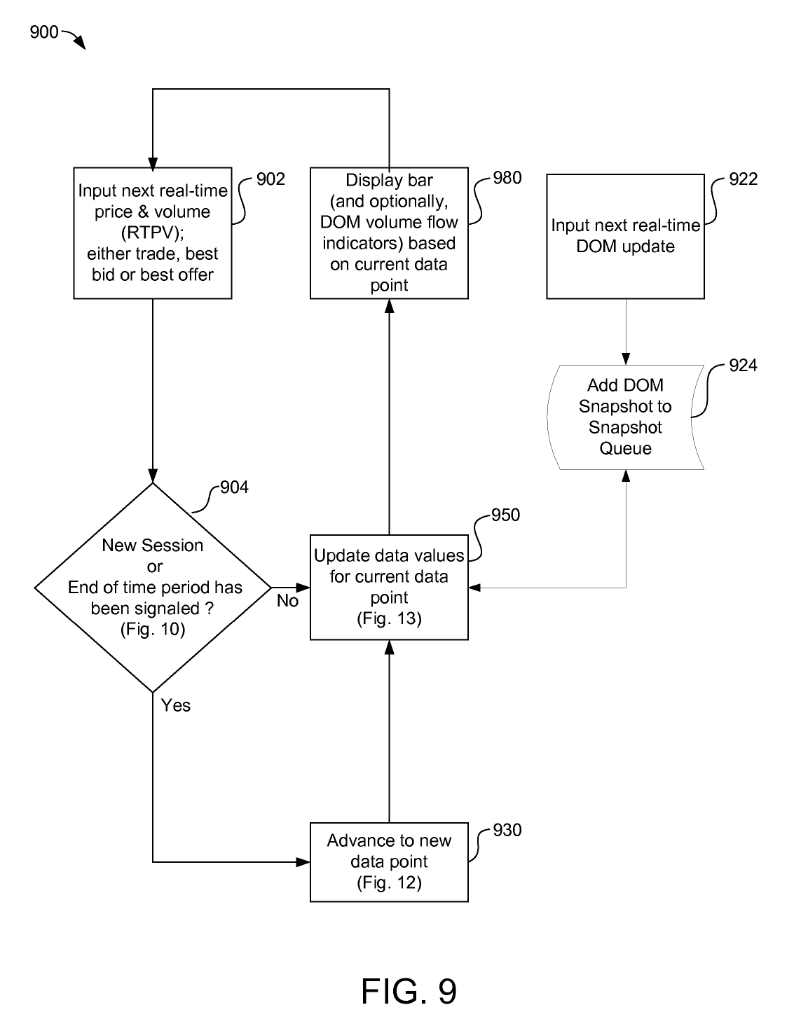

FIGS. 9 through 15 are flowcharts illustrating exemplary algorithms for generating bid/ask range data points and corresponding DOM volume flow values. While these algorithms are expressed in terms of real-time price and volume, other embodiments may apply to generation of data points utilizing input from a historical database of the price and volume information.

FIG. 9 is a flowchart illustrating an algorithm 900 for generating bid/ask range data points for a selected financial instrument in accordance with one embodiment of the present invention. In general, the data point generation algorithm 900 repeats over time, generating a new data point during each discrete time period as determined by the data point advancing algorithm 930 discussed below. While the algorithm 900 is expressed in terms of real-time price, volume, and depth of market updates, other embodiments may apply to generation of data points utilizing input from a historical database of price, volume, and depth of market information.

An inputting operation 902 receives the next or first real-time price and volume (RTPV) of the selected financial instrument for the associated time period. The RTPV may be obtained from an executed trade, a best bid pending in the market, or a best offer that is pending in the market.

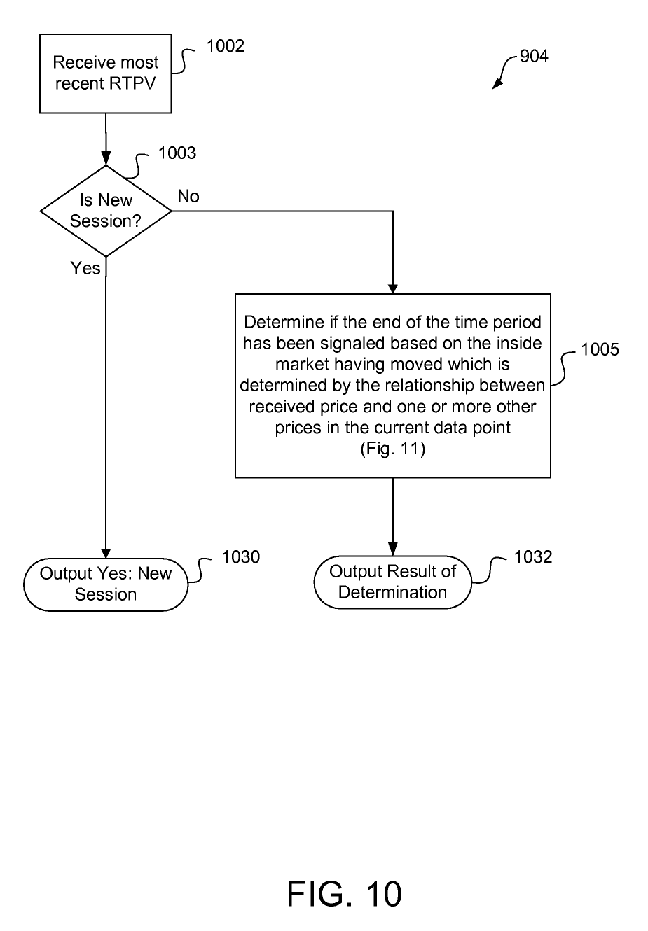

A query operation 904 determines if it is time to advance to a new bar in the bar chart. In accordance with various embodiments, the query operation 904 checks whether one of a set of specified bar advancing events has occurred. An exemplary algorithm illustrating one embodiment of the query operation 904 is shown in FIG. 10 and is discussed below. By way of example, but not limitation, the query operation 904 can check whether the inside market has moved or a new session has started. According to various embodiments, the start of a new session is defined by the exchange trading hours or by user defined custom session hours.

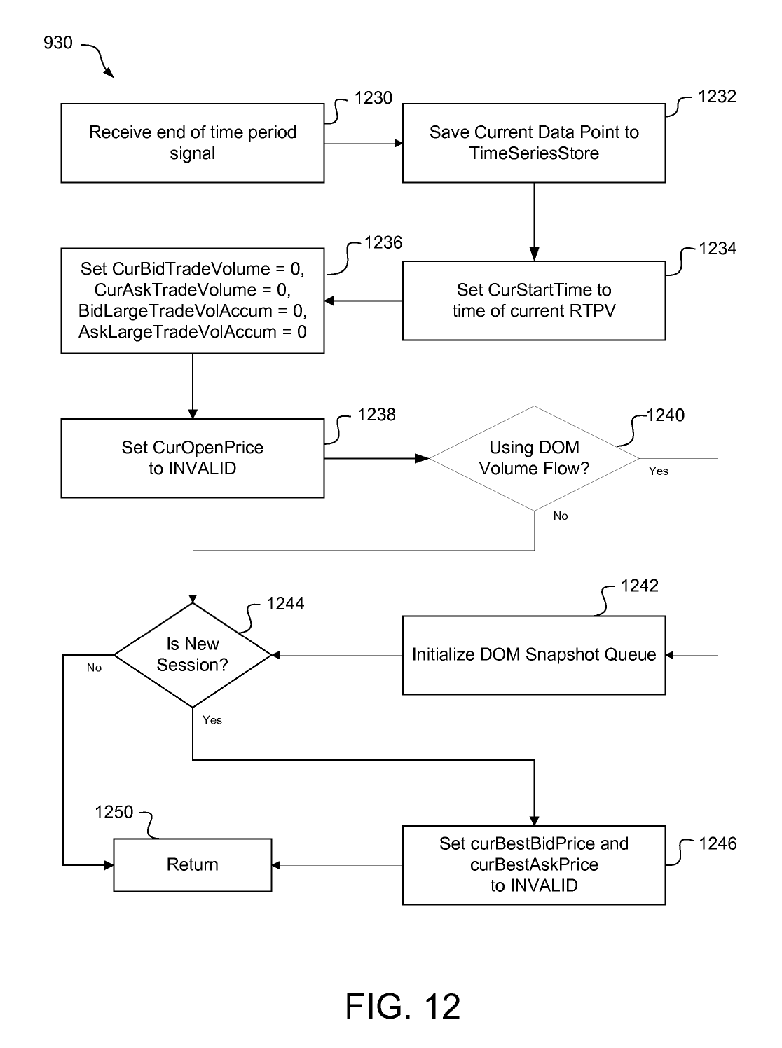

If the inside market has moved (or another bar advancing event has occurred), the data point generation algorithm 900 branches “Yes” to an advancing operation 930 which prepares to generate a new data point. In one embodiment, the advancing operation 930 initializes the data values associated with the new bid/ask range data point. An exemplary algorithm illustrating one embodiment of the advancing operation 930 is shown in FIG. 12 and discussed below.

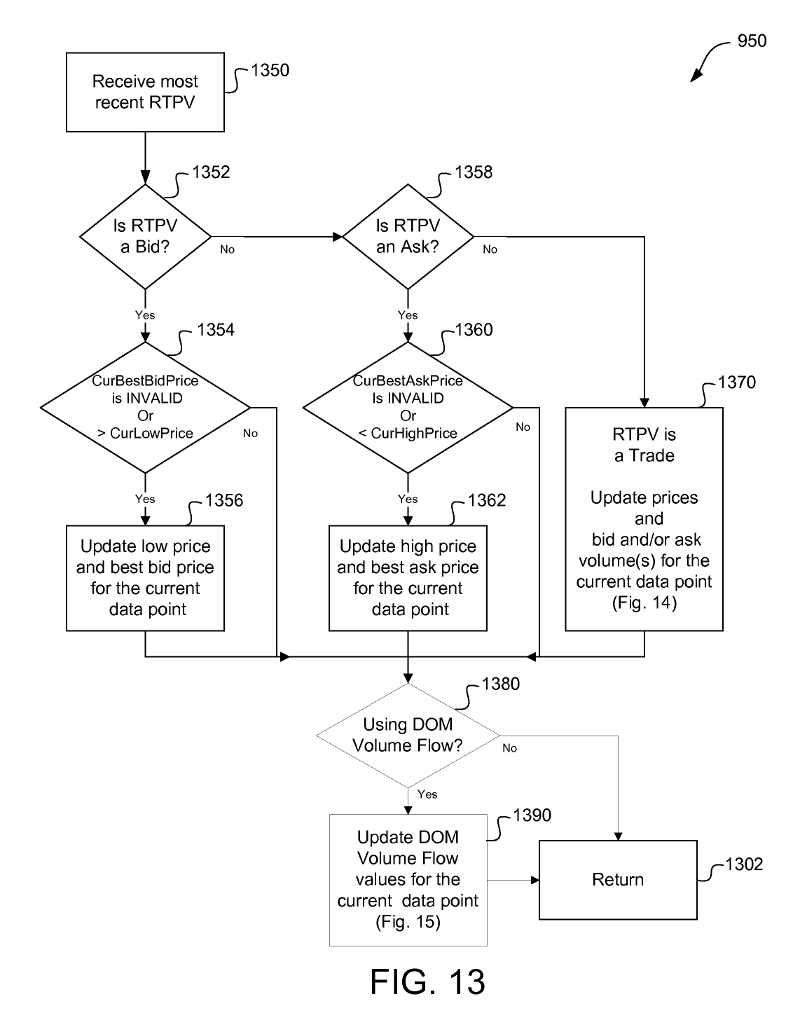

If the inside market has not moved (and no other bar advancing event has occurred), the data point generation algorithm 900 branches “No” to a data value updating operation 950. An exemplary algorithm illustrating one embodiment of the data value updating operation 950 is shown in FIG. 13 and discussed below.

In the data value updating operation 950, the RTPV received in the receiving operation 902 is used to update price and volume data values associated with the data point currently being determined; i.e., in the current time period.

The updating operation 950 also retrieves the DOM snapshot data from the DOM snapshot data store 924 and updates the DOM volume flow data values for the current data point. The DOM snapshot data store 924 receives input from the DOM real-time update receiving operation 922 and maintains a queue of DOM snapshots.

After the updating operation 950, the algorithm branches to a displaying operation 980. Displaying operation 980 displays a bar on the computer display screen, using the values stored in the current data point. In addition, the displaying operation 980 presents the bar using various display aspects, such as colors, color shades, color intensities, and bar widths, depending on the data values and configured settings (e.g., those set by the user using user interfaces 300 (FIG. 3) and 400 (FIG. 4). FIG. 2, discussed above, illustrates how bars could be displayed in accordance with one embodiment. If a histogram bar chart and/or an on-balance line chart are being displayed, they will also be advanced using values in the current data point.

Although not shown, other operations could take place using the current data point. For example, the current data point could be used for various studies or analyses, as well as automatic trading. These other operations, if any, could take place serially, or in parallel with, operations of algorithm 900.

From the displaying operation 980, the algorithm returns to the inputting operation 902, where the next RTPV is determined.

In some embodiments, data points are generated at various times during a trading session or trading sessions. Each data point corresponds to a finite time duration. In various embodiments, the start time and end time of each finite time duration are determined according to an algorithm 904, discussed further below. Between the start time and end time, the elements of the data point are calculated, as illustrated in FIG. 9 and discussed herein, based on financial data received from an electronic exchange.

FIG. 10 is a flowchart illustrating one embodiment of algorithm 904 for determining whether an advancing event has occurred. In this particular embodiment, it is determined whether the inside market has moved or a new session has started and thus to advance to a new bid/ask range data point for a selected financial instrument.

An inputting operation 1002 receives the next or first real-time price and volume (RTPV) of the selected financial instrument. The RTPV may be obtained from an executed trade, a best bid pending in the market, or a best offer that is pending in the market.

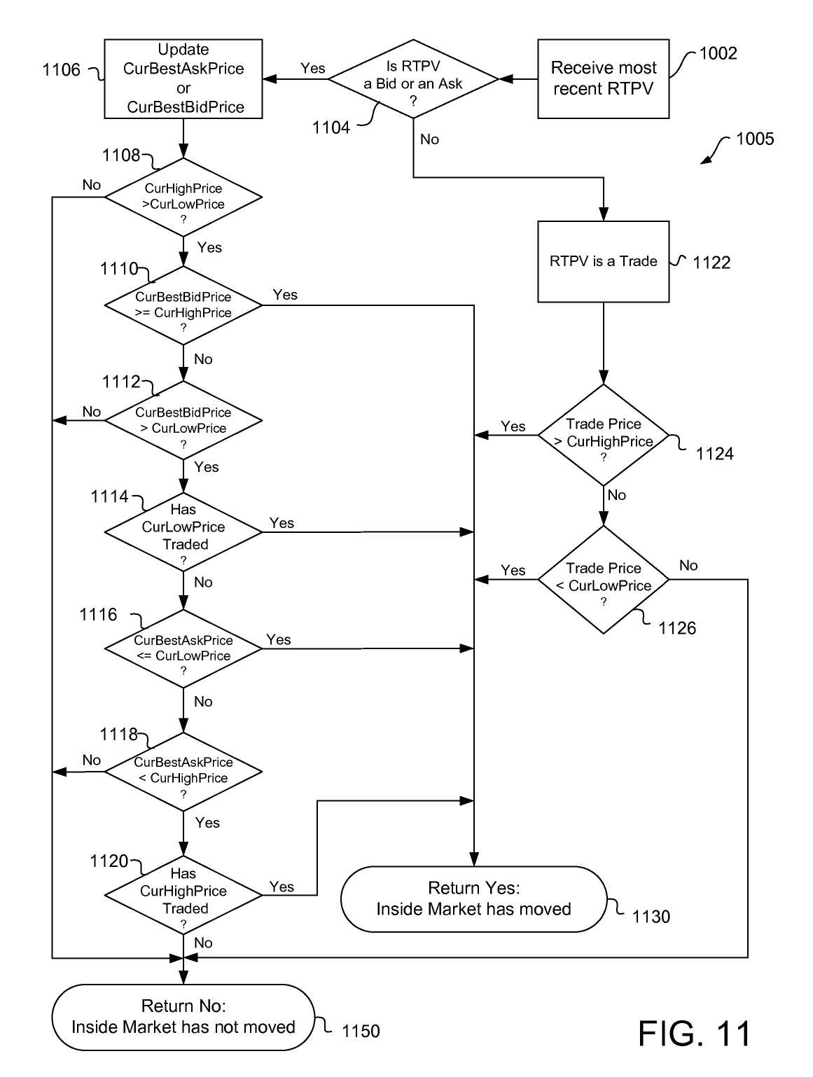

A query operation 1003 determines if the received RTPV is the first RTPV in a new session. If a new session has started, the algorithm 904 branches to returning operation 1030, which outputs an indication that a new session has started. If a new session has not started, the algorithm 904 branches to a determining operation 1005. The determining operation 1005 determines whether if the end of the time period has been signaled based on the inside market having moved which is determined at least in part, by a relationship or relationships between the received price and one or more other prices in the current data point, such as the current low price, the current high price, the current best ask price, and/or the current best bid price. An exemplary embodiment of the determining operation 1005 is illustrated in FIG. 11. After the determining operation 1005, the result of the determining operation 1005 is returned in a returning operation 1032.

In the embodiment shown in FIG. 11, initially a query operation 1104 receives an RTPV from the inputting operation 1102 and determines if the received RTPV corresponds to a bid or an ask. If the received RTPV corresponds to a bid or an ask, the algorithm 1005 branches to the update operation 1106 to set the current data point's best bid price to the received bid price or the best ask price to the received ask price and then to the query operation 1108 to determine if the current high price is greater than the current low price. If the result of the query operation 1108 is “No”, the algorithm branches to the output operation 1150.

If the result of query operation 1108 is “Yes”, the algorithm branches to the query operation 1110 to determine if the current best bid price is greater than or equal to the current data point's high price. If the result of query operation 1110 is “Yes”, the algorithm branches to the output operation 1130. If the result of query operation 1110 is “No”, the algorithm branches to the query operation 1112 to determine if the current best bid price is greater than the current low price. If the result of query operation 1112 is “No”, the algorithm branches to the output operation 1150.

If the result of query operation 1112 is “Yes”, the algorithm branches to the query operation 1114 to determine if any trade volume has been accrued for the current low price. In one embodiment, this involves determining whether the current low price has been traded. If the result of query operation 1114 is “Yes”, the algorithm branches to the output operation 1130.

If the result of query operation 1114 is “No”, the algorithm 1005 branches to the query operation 1116 to determine if the ask price is less than or equal to the current data point's low price. If the result of query operation 1116 is “Yes”, the algorithm branches to the output operation 1130. If the result of query operation 1116 is “No”, the algorithm branches to the query operation 1118 to determine if the ask price is less than the current high price. If the result of query operation 1118 is “No”, the algorithm branches to the output operation 1150.

If the result of query operation 1118 is “Yes”, the algorithm 1005 branches to the query operation 1120 to determine if any trade volume has been accrued for the current high price. In one embodiment, this involves determining whether the current high price has been traded. If the result of query operation 1120 is “Yes”, the algorithm branches to the output operation 1130. If the result of query operation 1120 is “No”, the algorithm branches to the output operation 1150 for the current data point.

Referring again to the query operation 1104, if the query operation 1104 determines that the received RTPV does not correspond to a bid or an ask, the algorithm 1005 branches to the operation 1122 because the RTPV is necessarily a trade, and then to the query operation 1124 to determine if the trade price is greater than the high price of the current data point. If the result of the query operation 1124 is “Yes”, the algorithm branches to the output operation 1130.

If the result of the query operation 1124 is “No”, the algorithm branches to the query operation 1126 to determine if the trade price is less than the low price of the current data point. If the result of the query operation 1126 is “Yes”, the algorithm branches to the output operation 1130. In output operation 1130, an indication is returned that the inside market has moved. If the result of query operation 1126 is “No”, the algorithm branches to the output operation 1150 for the current data point. In the output operation 1150, an indication is returned that the inside market has not moved.

In the embodiment of the algorithm 1005 shown in FIG. 11, the output operation 1130 returns “Yes” to indicate that the algorithm 900 (FIG. 9) should advance to a new data point. In the algorithm 1005, the output operation 1150 returns “No” to indicate that the algorithm 900 should branch to the current data point value update operation.

A new bid/ask range data point may be generated if the inside market changes, even though there has not been any trading activity.

In an alternative embodiment, a new aggregated data point may be generated according to an alternative algorithm defined by the aggregation over a collection of the bid/ask range data points resulting from changes in the inside market. The extent of the collection of bid/ask range data points may be user-defined.

A bid/ask range data point includes one or more data values such as, but not limited to a start time, an open price, a high price, a low price, a close price, a mid price, a bid trade volume due to all trades that were executed at the bid price, a bid trade volume due to large trades that were executed at the bid price, a bid DOM volume flow value, an ask trade volume due to all trades that were executed at the ask price, an ask trade volume due to large trades that were executed at the ask price, and an ask DOM volume flow value.

FIG. 12 is a flowchart illustrating one possible embodiment of algorithm 930 for advancing to a new data point. An inputting operation 1230 receives the end of time period signal of the selected financial instrument. A data save operation 1232 is performed to save the current data point to a time series data store. Then the algorithm branches to an initialization operation 1234 which sets the start time for the current data point equal to the time of the most currently received RTPV. An initialization operation 1236 sets the bid trade volume, the bid large trade volume accumulator, the ask trade volume, and the ask large trade volume accumulator for the current data point to zero and another initialization operation 1238 sets the open price of the current data point to INVALID.

The algorithm 930 then branches to the query operation 1240 to determine if the chart being displayed is a DOM volume flow study chart as described in FIG. 5. If the result of the query is “Yes”, then the algorithm branches to an initialization operation 1242 which initializes the DOM snapshot queue and then branches to the query operation 1244 to determine if a new session has started. If the result of the query operation 1242 is “No”, the algorithm branches directly to the query operation 1244.

If the result of the query operation 1244 is “No” the algorithm branches directly to the return operation 1250. If the result of the query operation 1244 is “Yes” then the algorithm branches to the initialization operation 1246 which sets the best bid price and the best ask price for the current data point to INVALID before proceeding to the return operation 1250.

In accordance with various embodiments, the open price represents the price of the first trade that was received for the current data point. If no trades occurred before the current data point is terminated then the open price is set to an invalid value.

According to at least one embodiment, the high price is set to either the highest ask price of the current data point that was traded or, if no trades occurred at the ask price, the lowest ask price that occurred over the duration of the current data point.

In exemplary embodiments the low price is set to either the lowest bid price of the current data point that was traded or, if no trades occurred at the bid price, the highest bid price that occurred over the duration of the current data point.

In accordance with some embodiments, the close price is set to the price of the last trade that was received for the current data point. The close price for the current data point is initialized to the close price of the prior data point. At the beginning of a session, the close price is initialized to an invalid value. The close price remains invalid until a trade occurs.

FIG. 13 is a flowchart illustrating an embodiment of algorithm 950 for updating the current data point values. An inputting operation 1350 receives the next or first real-time price and volume (RTPV) of the selected financial instrument and branches to the query operation 1352 to determine if the RTPV is a bid. If the result of the query operation 1352 is “Yes”, the algorithm branches to a query operation 1354 to determine if the current best bid price is INVALID or if the real time price (RTP) is greater that the low price of the current data point. If the result of the query operation 1354 is “No”, the algorithm 950 branches directly to the query operation 1380. If the result of the query operation 1354 is “Yes”, the algorithm 950 branches to the updating operation 1356 which sets the low price and the best bid price of the current data point equal to the RTP.

If the result of the query operation 1352 in “No”, the algorithm 950 branches to a query operation 1358 to determine if the RTPV is an ask. If the result of the query operation 1358 is “Yes”, the algorithm 950 branches to the query operation 1360 to determine if the current best ask price is INVALID or if the RTP is less than the high price of the current data point. If the result of the query operation 1360 is “No”, the algorithm 950 branches directly to the query operation 1380. If the result of the query operation 1360 is “Yes”, the algorithm 950 branches to the updating operation 1362 which sets the high price and the best ask price of the current data point equal to the RTP.

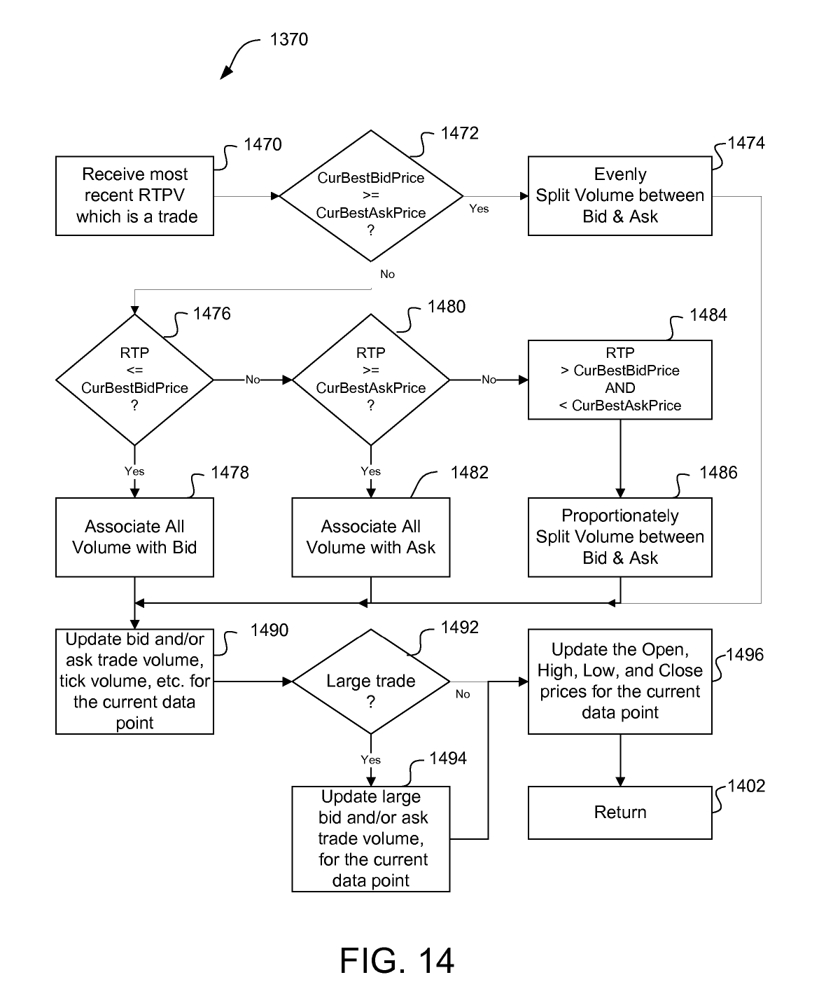

If the result of the query operation 1358 in “No”, the RTPV is a trade and the algorithm branches to an updating operation 1370 which sets price and volume values for the current data point and then to the query operation 1380. Information regarding the distribution of traded volume at a particular price or within a particular price range may be categorized and displayed in bar chart form as “bid trade volume”, that is, volume traded at the bid price, or “ask trade volume”, that is, volume traded at the ask price, to illustrate the relative volume of trading activity occurring as favoring either buying or selling. In an exemplary embodiment, trade volume is allocated either as bid trade volume or as ask trade volume according to the algorithm 1370 as described in the flowchart in FIG. 14 and discussed below.

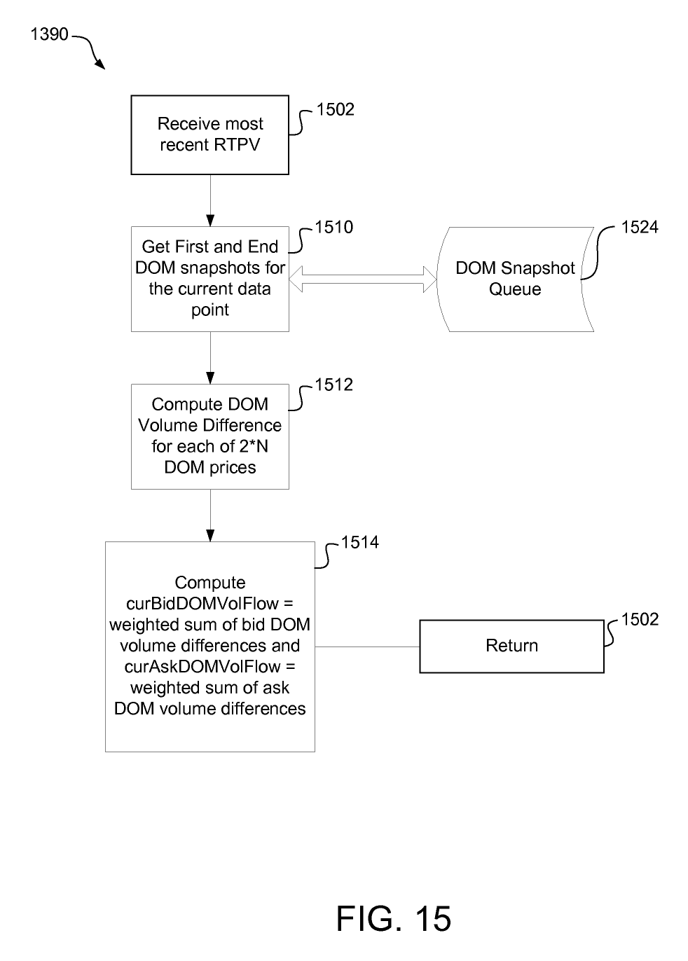

In the query operation 1380, the algorithm 950 determines if DOM volume flow values are required for the current data point. That is, the bid/ask range chart being displayed includes a DOM volume flow study overlay as described in FIG. 5, or DOM volume flow values are to be computed for use by other analyses. The user may set whether the DOM volume flow study chart is displayed and/or whether DOM volume flow values will be used for other analyses. The query operation 1380 tests one or more user settings to determine if the user selected to compute DOM volume flow values for any purpose. If the result of the query is “Yes”, then the algorithm branches to the update operation 1390 which updates the DOM volume flow values for the current data point. An exemplary embodiment of the updating operation 1390 is illustrated in FIG. 15 and discussed below.

In an exemplary embodiment, trade volume is allocated either as bid trade volume or as ask trade volume. If the price of a trade is less than or equal to the price of the current best bid, all of the trade's volume is associated with the bid.

If the price of a trade is greater than or equal to the price of the current best ask, all of the trade's volume is associated with the ask.

If the price of a trade is less than the price of the current best ask and greater than the price of the current best bid, the trade's volume is split among the bid and ask. In one embodiment, the amount of the trade volume attributed to the bid and the ask of the trade is proportional to the distance from the trade price to the best bid price and the best ask price (the closer the trade price is to the best bid price, the more volume of the trade is associated with the bid).

According to various embodiments, the bid trade volume is set to the volume of the trades on the bid side, accumulated over the duration of the current data point. Ask trade volume is set to the volume of the trades on the ask side, accumulated over the duration of the current data point.

A market may become “crossed” during the pre-open period or, for some instrument types, even during an active market. Therefore, embodiments of the data point generating algorithm properly accommodate the “crossed” state. If the best bid and best ask prices are equal or crossed and a trade occurs, half of the trade's volume is associated with the bid and half of its volume is associated with the ask.

In an alternative embodiment, the bid trade volume and the ask trade volume may be further categorized as having resulted from large trades.

FIG. 14 is a flowchart illustrating an embodiment of algorithm 1370 for updating the price and volume values for current data point. As discussed above, the updating operation 1370 occurs when the received real-time price and volume (RTPV) correspond to an executed trade. In general, the algorithm 1370 shown in FIG. 14 accommodates multiple situations in which a trade could have been executed, with reference to the current best bid order (or simply “the bid”) and the current best ask order (or simply “the ask”). Depending on the situation, the volume of the trade, or a portion of the volume of the trade, may be attributed to the bid or the ask.

Attributing volume (or a portion thereof) to a bid or an ask generally refers to associating the volume (or a portion thereof) with the best bid or the best ask. In other words, FIG. 14 may be understood as determining what portion of a trade's volume is to be allocated to the bid or the ask. In some cases, all of the trade volume is attributed to the bid, with none of the volume being attributed to the ask. In other cases, all of the trade volume is attributed to the ask, with none of the volume being attributed to the bid. In still other cases, a portion of the volume is attributed to the bid, and a portion of the volume is attributed to the ask. In the embodiment shown in FIG. 14, the determination as to how to “split” or apportion the trade volume to the bid and/or the ask is made based on the relative values of the best bid price, the best ask price, and the trade price.

Prior to discussing the details of the algorithm 1370, it should be noted that while determining whether a traded volume should be attributed to a large trade, the algorithm 1370 accommodates a large order split into multiple parts because only smaller counterparty orders exist in the counterparty order queue or depth of market. For example, if an order to buy calls for one hundred shares, and the first order in the ask queue is smaller than one hundred shares, the buy order may be matched with a sell order in the ask queue for twenty shares, another sell order in the ask queue for thirty shares, and a final sell order in ask queue for fifty shares. During this trade sequence, multiple trade RTPVs may be received in the algorithm 1370 without any updates to the best ask volume and the volume is associated with the ask and is accumulated to determine the total volume of the trade. A large trade sequence is terminated when an RTPV other than of the type trade is received or when it has been determined that the inside market has moved.

Referring now more specifically to FIG. 14, an inputting operation 1470 receives the next or first real-time price and volume (RTPV) of the selected financial instrument which is a trade and branches to the query operation 1472 to determine if the best bid price is greater than or equal to the best ask price of the current data point. If the result of the query operation 1472 is “Yes”, the algorithm 1370 branches to the assignment operation 1474 which allocates the trade volume equally between the bid and the ask and then to the updating operation 1490.

If the result of the query operation 1472 is “No”, the algorithm 1370 branches to the query operation 1476 to determine if the real time price (RTP) is less than or equal to the best bid price of the current data point. If the result of query operation 1476 is “Yes”, the algorithm 1370 branches to the assignment operation 1478 which allocates all of the trade volume to the bid before proceeding to the updating operation 1490.

If the result of the query operation 1476 is “No”, the algorithm 1370 branches to the query operation 1480 to determine if the RTP is greater than or equal to the best ask price of the current data point. If the result of query operation 1480 is “Yes”, the algorithm 1370 branches to the assignment operation 1482 which allocates all of the trade volume to the ask before proceeding to the updating operation 1490.

If the result of the query operation 1480 is “No”, then the RTP is greater than the best bid price and less than the best ask price of the current data point as is expressed by the statement 1484. The algorithm 1370 thus branches to the assignment operation 1486 which proportionately allocates the trade volume to the bid and the ask based on the relationship of the RTP to the best bid price and the best ask price of the current data point before proceeding to the updating operation 1490.

In the updating operation 1490, the following values are updated: bid trade volume and the ask trade volume of the current data point, a bid large trade volume accumulator and an ask large trade volume accumulator, and the bid tick volume and the ask tick volume for the current data point. Each of the foregoing values are updated by adding in the trade volume from the RTPV the value according the previously determined proportions (i.e., the proportions attributed in steps 1476, 1480, and 1484).

Then the algorithm 1370 branches to the query operation 1492 to determine whether either the bid large trade volume accumulator or the ask large trade volume accumulator exceeds the large volume threshold (e.g., a threshold set by threshold specification element 404, FIG. 4). As discussed above, during a sweep, the trade volume attributed to the sweeping order is accumulated. The bid large trade volume accumulator and the ask large trade volume accumulator are updated from successive RTPV trade volumes that are due to trades without any intervening bid RTPV or ask RTPV. When an intervening bid or ask order is received, the sweep is considered to be completed. To account for the end of a sweep situation, when a bid RTPV is received, the bid large trade volume accumulator is reset to zero. Similarly, when an ask RTPV is received, the ask large trade volume accumulator is reset to zero.

If the result of the query operation 1492 is “No”, the algorithm 1370 branches directly to the updating operation 1496. If the result of the query operation 1492 in “Yes”, the algorithm 1370 branches to the updating operation 1494.

In the updating operation 1494, the bid large trade volume value and/or the ask large trade volume value are updated. If the proportion of the trade volume previously allocated to the bid is greater than zero and the bid large trade volume accumulator exceeds the large trade volume threshold, the bid large trade volume is updated by adding the bid large trade volume accumulator into the bid large volume, and then setting the bid large trade volume accumulator to zero. Similarly, if the proportion of the trade volume previously allocation to the ask is greater than zero and the ask large trade volume accumulator exceeds the large trade volume threshold, the ask large trade volume is updated by adding the ask large trade volume accumulator into the ask large volume, and then setting the ask large trade volume accumulator to zero. The algorithm 1370 then proceeds to the updating operation 1496.

In the updating operation 1496, if the open price of the current data point has not yet been set (e.g., the open price is INVALID or some other default value), the open price is set to the RTP. If the RTP is greater than the high price of the current data point, the high price is set to the RTP. If the RTP is less than the low price of the current data point, the low price is set equal to the RTP. Then the close price of the current data point is set equal to the RTP. Then the algorithm 1370 branches to the return operation 1402 to return to the calling process.

In an alternative embodiment, volume traded at the best bid price may be further categorized as “up bid trade volume” or “down bid trade volume” depending on the direction of the movement of the inside market. Similarly, volume traded at the best ask price may be further categorized as “up ask trade volume” or “down ask trade volume” depending on the direction of the movement of the inside market.

FIG. 15 is a flowchart illustrating an embodiment of a DOM volume flow updating algorithm 1390 for updating the DOM volume flow values for a current data point. As discussed above, the updating algorithm 1390 is executed when a real-time price and volume (RTPV) is received and the user has chosen to display the DOM volume flow on a bid/ask range chart or has chosen to utilize the DOM volume flow data values in an auxiliary analysis.

In one embodiment of the algorithm 1390, an inputting operation 1502 receives the next or first real-time market price and volume (RTPV) of the selected financial instrument and branches to the data retrieval operation 1510 to get the first and end DOM snapshots for the current data point. The algorithm then branches to the computation operation 1512 to compute the volume difference for each of N bid DOM prices and N ask DOM prices. Then algorithm branches to the computational operation 1514 to compute the bid DOM volume flow value and the ask DOM volume flow value. The bid DOM volume flow can be calculated as the weighted sum of the N bid DOM volume differences. The ask DOM volume flow value can be calculated as the weighted sum of the N ask DOM volume differences. As discussed previously and illustrated by an exemplary user interface 600 in FIG. 6, the weights used in the DOM volume flow calculation may be user configurable.

In accordance with one embodiment of the present invention, new price and corresponding bid trade volume and ask trade volume data points are generated and rendered on a bid/ask range bar chart according to the rendering rules described herein.

In one embodiment, a bid/ask range bar chart may be appended to a financial instrument trading interface, such as a dynamic price scale trading interface. The bid/ask range bar chart may provide to a trader various visual indications of buying or selling pressure in the market place, permitting the trader to make potentially more profitable trading decisions.

According to one embodiment, an end user, such as a trader, may be able to set volume levels that are used to determine the intensity of the color and/or the width of the bid/ask range bars. The volume levels may be expressed as absolute values, as a percent rank relative to historical volume values, or as percentages of a base volume where the base volume may be expressed as an absolute value or be algorithmically determined, for example, by calculating a median or a moving average of the historical volume values. Other algorithms may be used to determine the base volume. Because the volume levels can be quite different for different trading sessions, data may be segregated by session when using the historical data to determine the relative rank or the base volume level. The user may also explicitly set the colors that are used to shade the bars at the various traded volume levels.

In one embodiment, the bid/ask range data point's open price, high price, low price, close price, mid price, bid trade volume, or ask trade volume, may be used with additional analyses, such as a moving average or rate-of-change. As other examples, the result(s) of an analysis may be displayed in various manners, such as, but not limited to, an overlay on a bid/ask range chart, or in a separate window pane concurrently with, or independent of, other analytical displays and/or a trading interface. As yet another example, the result(s) of an analysis may also be used to create conditions that trigger the placement of orders to buy or sell a particular financial instrument.

In one embodiment, a bid/ask volume histogram chart including bars that illustrate the distribution of the volume traded at the best bid price and volume traded at the best ask price corresponding to a bar on a bid/ask range chart may be displayed concurrently with or independent of a bid/ask range chart and/or a trading interface. The volume bars may be displayed with the bid trade volume as a negative histogram bar colored red and the ask trade volume as a positive histogram bar colored green. Alternatively, the bid trade volume and the ask trade volume may be displayed as overlain positive histogram bars of different colors and/or widths.

In the alternative embodiment where the bid trade volume and the ask trade volume are further categorized as having resulted from large trades, the end user may specify the volume level that determines the boundary between that identifies a large trades. The volume level may be expressed as an absolute value, as a percent rank relative to historical volume values, or as a percentage of a base volume where the base volume may be expressed as an absolute value or be algorithmically determined, for example, by calculating a median or a moving average of the historical volume values. Other algorithms may be used to determine the base volume. Because the volume levels can be quite different for different trading sessions, data may be segregated by session when using the historical data to determine the relative rank or the base volume level.

The volume bars may then be displayed with the bid trade volume as a negative histogram bar with two colors, for example, bright red for the portion of the bid trade volume resulting from large trades and dark red for the remaining portion of the bid trade volume and the ask trade volume as a positive histogram bar with two colors, for example, bright green for the portion of the ask trade volume resulting from large trades and dark green for the remaining portion of the ask trade volume. Alternatively, the bid trade volume and the ask trade volume may be displayed as overlain positive histogram bars of different colors and widths.

In one embodiment, a bid/ask on-balance volume line chart including a display of a line graph of the positive aggregation of the volume traded as the ask price corresponding to a bar on a bid/ask range chart and negative aggregation of the volume traded at the bid price corresponding to a bar on a bid/ask range chart may be displayed concurrently with or independent of a bid/ask range chart and/or a bid/ask volume chart and/or a trading interface.

In an alternative embodiment, a bid/ask on-balance volume line chart including the display of a line graph of the positive aggregation of the “up bid trade volume” and the weighted “up ask trade volume” when the inside market moves up and negative aggregation of the “down ask trade volume” and the weighted “down bid trade volume” when the market moves down may be displayed concurrently with or independent of a bid/ask range chart and/or a bid/ask volume chart and/or a trading interface.

In one embodiment, the on-balance volume values may be used with additional analyses, such as a moving average or rate-of-change. As other examples, the result(s) of an analysis may be displayed in various manners, such as, but not limited to, an overlay on a bid/ask range chart, or in a separate window pane concurrently with, or independent of, other analytical displays and/or a trading interface. As yet another example, the result(s) of an analysis may also be used to create conditions that trigger the placement of orders to buy or sell a particular financial instrument.

According to one embodiment, a bid/ask on-balance volume oscillator line chart including a display of a line graph of the difference between one moving average calculated using on-balance volume values and one set of parameters and another moving average calculated using on-balance volume values and a different set of parameters may be displayed concurrently with or independent of a bid/ask range chart and/or a bid/ask volume chart and/or any other analytical displays and/or a trading interface. In contrast to the bid/ask on-balance volume, the on-balance volume oscillator has values that are independent of the historical start time of the on-balance volume calculation.

In one embodiment, the on-balance volume oscillator values may be used with additional analyses, such as a moving average or rate-of-change. As other examples, the result(s) of an analysis may be displayed in various manners, such as, but not limited to, an overlay on a bid/ask range chart, or in a separate window pane concurrently with, or independent of, other analytical displays and/or a trading interface. As yet another example, the result(s) of an analysis may also be used to create conditions that trigger the placement of orders to buy or sell a particular financial instrument.

In one embodiment, the on-balance volume oscillator values may be used with additional analyses, such as a moving average or rate-of-change. The result of an analysis may be displayed either as an overlay on a bid/ask range chart or in a separate window pane concurrently with or independent of other analytical displays and/or a trading interface. The result of an analysis may also be used to create conditions that trigger the placement of orders to buy or sell a particular financial instrument.

Display or suppression of any of the described graphical user interface screens may be configurable by the end user and/or responsive to end user request.

Exemplary Computing Device

Embodiments of the present invention include various steps that may be performed by hardware components or may be embodied in machine-executable instructions, which may be used to cause a general-purpose or special-purpose processor programmed with the instructions to perform the steps. Alternatively, the steps may be performed by a combination of hardware, software, firmware or human representatives of the parties or entities involved in the transaction.

Embodiments of the present invention may be provided at least in part as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

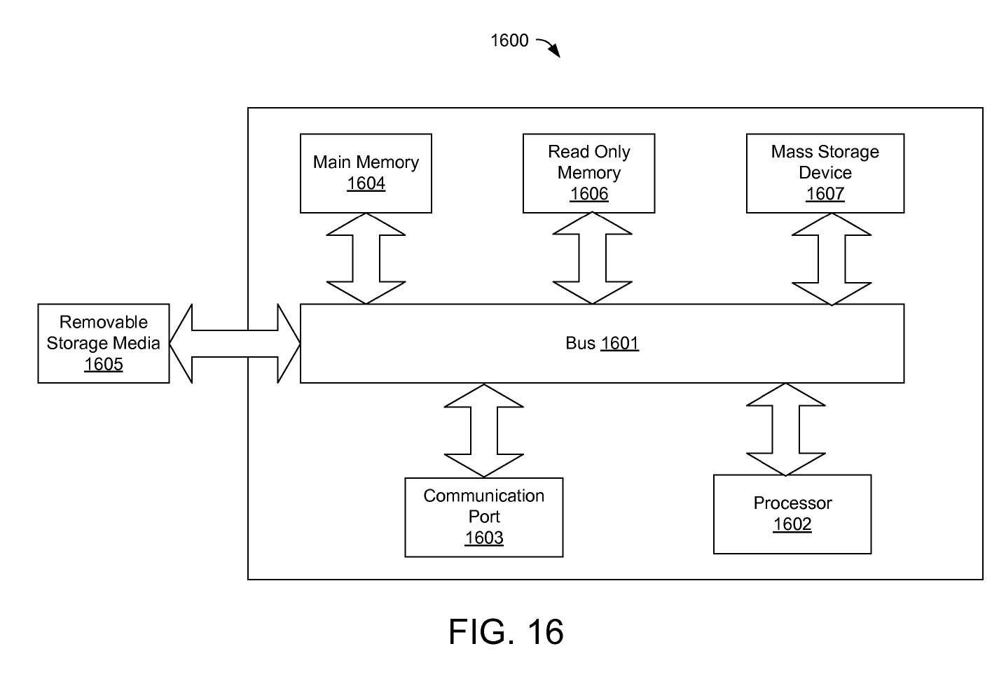

FIG. 16 is a schematic diagram of a computing device 1600 upon which a server or client side financial trading and/or analysis application may execute. According to the present example, the computing device 1600 includes a bus 1601, at least one processor 1602, at least one communication port 1603, a main memory 1604, a removable storage media 1605 a read only memory 1606, and a mass storage 1607. Processor(s) 1602 can be any know processor, such as, but not limited to, an Intel® Itanium® or Itanium 2® processor(s), or AMD® Opteron® or Athlon MP® processor(s), or Motorola® lines of processors. Communication port(s) 1603 can be any of an RS-232 port for use with a modem based dialup connection, a 10/100 Ethernet port, or a Gigabit port using copper or fiber. Communication port(s) 1603 may be chosen depending on a network such a Local Area Network (LAN), Wide Area Network (WAN), or any network to which the computing device 1600 connects. The computing device 1600 may be in communication with peripheral devices (not shown) such as, but not limited to, printers, speakers, cameras, microphones, or scanners.

Main memory 1604 can be Random Access Memory (RAM), or any other dynamic storage device(s) commonly known in the art. Read only memory 1606 can be any static storage device(s) such as Programmable Read Only Memory (PROM) chips for storing static information such as instructions for processor 1602. Mass storage 1107 can be used to store information and instructions. For example, hard disks such as the Adaptec® family of SCSI drives, an optical disc, an array of disks such as RAID, such as the Adaptec family of RAID drives, or any other mass storage devices may be used.

Bus 1601 communicatively couples processor(s) 1602 with the other memory, storage and communication blocks. Bus 1601 can be a PCI/PCI-X or SCSI based system bus depending on the storage devices used. Removable storage media 1605 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While, for convenience, embodiments of the present invention are described herein with reference to specific data processing algorithms, bid/ask range charts, bid/ask volume charts and specific user interface screens for trading financial instruments in the form of dynamic price scales, the techniques described are equally applicable to various other types and structures of charts and trading paradigms.

1. A method for generating a depth of market (DOM) volume flow chart, the method comprising:
monitoring DOM volume of a financial instrument, wherein the DOM volume includes volume elements corresponding to bid order volume and ask order volume of orders for the financial instrument that are open on an electronic exchange;
computing a DOM volume flow including a bid DOM volume flow and an ask DOM volume flow by evaluating a function of the DOM volume; and
displaying indicators of the computed DOM volume flow including the ask DOM volume flow and the bid DOM volume flow.

2. The method of claim 1, further comprising determining changes in each of the volume elements corresponding to a price associated with the volume elements and wherein the function of DOM volume is computed by weighting a sum of the changes of a subset of the volume elements.

3. (canceled)

4. The method of claim 1, wherein computing a function of DOM volume comprises:
creating a value table including a starting volume column and an ending column volume;
populating the starting volume column with volume values at a starting time, wherein rows of the starting volume column corresponding to different prices within the DOM at the starting time;
populating the ending volume column with volume values at an ending time, wherein rows of the ending volume column corresponding to different prices within the DOM at the ending time;
computing the difference between the volume elements at corresponding prices in the starting volume column and the ending volume column to create volume flow data;
accessing a table with weight values associated with each price; and
multiplying the weight values associated with each price by the corresponding computed difference between the volume elements.

5. The method of claim 4, wherein the ending time is determined by an end of time period determining function.

6. The method of claim 5 wherein the ending end of time period determining function returns a fixed time interval after the starting time.

7. The method of claim 5 wherein the ending end of time period determining function returns a dynamic time interval after the starting time by evaluating a function of one or more of traded prices, ask prices, ask volumes, change in ask volumes, bid prices, bid volumes, change in bid volumes, movement of the inside market, or trade volumes.

8. The method of claim 1, further comprising:
displaying a price bar chart with a plurality of price bars; and
locating the indicators of the computed DOM volume flow above or below the plurality price bars.

9. The method of claim 8, wherein the indicators are arrows.

10. The method of claim 9, further comprising varying the size of arrows based on the DOM volume over a discrete time period.

11. The method of claim 9, further comprising associating a color in the arrows to indicate a DOM volume flow direction.

12. The method of claim 9, wherein the indicators include arrows that point down when a total weighted net change in ask DOM volume is positive and arrows that point up when the total weighted net change in the ask DOM volume is negative.

13. The method of claim 9, wherein the indicators include arrows that point down when a total weighted net change in bid DOM volume is negative and arrows that point up when the total weighted net change in the bid DOM volume is positive.

14. The method of claim 1, further comprising:
displaying a price bar chart with a plurality of price bars if a display indicator is received; and
displaying the values of the computed DOM volume flow in a line chart attached to the price bar chart.

15. The method of claim 1, further comprising:
displaying an price bar chart with a plurality of price bars if a display indicator is received; and
displaying the values of the computed DOM volume flow in a histogram chart attached to the price bar chart.

16. A system comprising:
a financial exchange interface module configured to receive financial instrument data from a financial exchange, wherein the financial instrument data includes volume elements corresponding to bid order volume and ask order volume for a financial instrument that are open on an electronic exchange;
an evaluation module configured to evaluate a function of the volume elements received by the financial exchange interface module; and
a indicator rendering module configured to graphically display evaluations of the function received form the evaluation module on a display device.

17. The system of claim 16, wherein the indicator rendering module displays evaluations of the function as arrows.

18. The system of claim 16, wherein the indicator rendering module varies the size of arrows based on the change in volume of open orders of the financial instrument on the electronic exchange over a discrete time period.

19. The system of claim 16, wherein the indicator rendering module assigns a color of the arrows to indicate a depth of market (DOM) volume flow direction.

20. The system of claim 16, wherein the indicator rendering module generates arrows that point down when a total weighted net change in ask DOM volume is positive and arrows that point up when the total weighted net change in ask DOM volume is negative.

21. The system of claim 16, wherein the indicator rendering module generates arrows that point down when a total weighted net change in bid DOM volume is negative and arrows that point up when the total weighted net change in the bid DOM volume is positive.

22. A system for trading financial instruments on an electronic exchange, the system comprising:
a display device operable to display a graphical user interface;
a microprocessor in communication with the display device and operable to execute instructions stored in memory;
a memory having microprocessor executable instructions, wherein the microprocessor executable instructions cause the microprocessor to communicate display data to cause a depth of market (DOM) volume flow chart to be displayed on the display device, wherein the display data is determined by monitoring volume elements corresponding to bid order volume and ask order volume of open orders for a financial instrument, computing a DOM volume flow including a bid DOM volume flow and an ask DOM volume flow by evaluating a function of the volume elements, and displaying indicators of the computed DOM volume flow including an ask DOM volume flow and a bid DOM volume flow.

23. The system of claim 22, wherein the microprocessor executable instructions further cause the microprocessor to determine changes in each of the volume elements corresponding to a price associated with the volume elements and compute the function of DOM volume by weighting a sum of the changes of a subset of the volume elements.

24. The system of claim 22, wherein the microprocessor executable instructions further cause a bid/ask range chart with a plurality of bid/ask range bars to be displayed on the display device; and locating indicators of the computed DOM volume flow above or below the plurality of bid/ask range bars.

25. The system of claim 22, wherein the microprocessor executable instructions cause the microprocessor to compute the function of DOM volume by:
creating a value table including a starting volume column and an ending column volume;
populating the starting volume column with volume values at a starting time, wherein rows of the starting volume column corresponding to different prices within the DOM at the starting time;
populating the ending volume column with volume values at an ending time, wherein rows of the ending volume column corresponding to different prices within the DOM at the ending time;
computing the difference between the volume elements at corresponding prices in the starting volume column and the ending volume column to create volume flow data;
accessing a table with weight values associated with each price; and
multiplying the weight values associated with each price by the corresponding computed difference between the volume elements.

26. A computer-readable storage medium containing a set of instructions capable of causing one or more processors to:
monitor a DOM volume of a financial instrument, wherein the DOM volume includes volume elements corresponding to bid order volume and ask order volume of orders for the financial instrument that are open on an electronic exchange;
determine changes in each of the volume elements corresponding to a price associated with the volume elements;
compute a DOM volume flow including a bid DOM volume flow and an ask DOM volume flow by evaluating a function of the DOM volume; and
display indicators of the computed DOM volume flow including the ask DOM volume flow and the bid DOM volume flow.
